(19) United States
(12) Patent Application Publication
(10) Pub. No.: US 2014/0015240 A1
(43) Pub. Date: Jan. 16, 2014

(54) PHOTOCOPY PAPER HAVING PRE-PRINTED MATERIAL FOR MARKETING ADVERTISING

(71) Applicant: Hsin-Fa YANG, Pingzhen City (TW)

(72) Inventor: Hsin-Fa YANG, Pingzhen City (TW)

(21) Appl. No.: 13/547,055

(22) Filed: Jul. 12, 2012

(51) Int. Cl. B42D 15/00

(52) U.S. Cl. 283/56

(57) ABSTRACT

A photocopy paper having pre-printed material for marketing advertising comprises a pre-printed surface and a blank surface, wherein the pre-printed surface and the blank surface are respectively disposed at two surfaces of the photocopy paper. A pattern layer having advertising scripts or patterns is pre-printed on the pre-printed surface. The pattern layer can be taking up a portion of the pre-printed surface or the whole pre-printed surface. The feature of the photocopy paper is that the blank surface can be provided for general photocopying purpose while the pre-printed surface can take benefit from advertising to reduce costs of papers. Moreover, the photocopy paper can be directly delivered to users' working or office locations such resource consumption problem caused by randomly delivering papers on the street can be replaced to effectively improve the advertising effect.

### BACKGROUND OF THE INVENTION

1. Field of the Invention

This invention generally relates to the field of photocopy paper. In particular referring to one side pre-printed photocopy paper so that the other side can be utilized for general purpose. This is applicable to effective placement purposes, but not limited to it, of getting information, messages, pictures and materials etc. across as a new form of marketing, advertising and/or communicating.

2. Description of the Related Art

Currently, conventional photocopy practices only use one side of the paper, leaving the reverse side blank. This cause wastage.

This practice of single-sided usage of photocopy paper in many organizations produces more trash afterwards, because the used paper is treated as non-reusable due to the confidentiality of the contents printed; or that the rate of reusing the paper is too low to be effective to reduce the cost of paper in these organizations. Moreover, majority of the types of the 70 GSM photocopy paper are unable to be utilized on both sides.

Accordingly to the inventor, the present invention provides photocopy paper having pre-printed material on one side, in the form of information, graphics, documents etc. to achieve effective marketing, advertising and/or communication, while can still be utilized as a general photocopy paper on the other side. As one illustration, pre-printed material such as advertising message provided by the advertiser is printed on one side of the photocopy paper, so while reading the intended contents by the user on the other side, the advertising effect of placement marketing can be achieved when the users read the reverse side (the pre-printed side) of the paper. Moreover, the photocopy paper can be directly delivered to users' working or office locations such that resource can be saved by doing without the traditional method of randomly distribution of papers on the street; this effectively improve the advertising effect. Therefore the waste of specialized advertising paper such as pamphlets and flyers in this case can be avoided, contributing to energy-saving and carbon reduction.

### SUMMARY OF THE INVENTION

To solve the current problem of wastage and poor utilization of photocopy paper as a communication medium in the conventional single-sided usage, it is an objective of the present invention to provide a photocopy paper that has pre-printed material for marketing, advertising and/or communicating on one side of the photocopy paper in a partial-paged or full-paged manner, leaving the other side blank for general use.

To achieve the above mentioned objective, the invention is a photocopy paper having pre-printed material to provide means for marketing, advertising and/or communication, comprising a blank surface located at a surface of the photocopy paper for users for general use or photocopy, and a pre-printed surface located on the other surface of the photocopy paper. The pre-printed surface is disposed with a first pattern layer. The first pattern layer is disposed by corresponding to the advertising message and disposed to a portion (partial-paged) or the whole (full-paged) of the pre-printed surface. The pre-printed material can be materials such as, but not limited to information, pictures, documents, patterns, stories, puzzles, games, and/or jokes etc. that is anything to enhance the interest of readers, thereby increasing the readership effect.

Further, a second pattern layer is disposed at random corners of the pre-printing surface of the photocopying paper. The second pattern layer corresponds to a number or an identification code of the advertising message to facilitate the interaction between users, readers, content providers, and advertisers for the relevant purposes.

In an embodiment, the size of the photocopy paper is one of specifications selected from, but not limited to A3, B3, A4, B4, A5 and B5.

In an embodiment, to increase the neatness and tidiness of the first pattern layer and the second pattern layer during reading, a first frame and a second frame are disposed on the pre-printing surface to respectively dispose the first pattern layer in the first frame and the second pattern layer in the second frame, thereby greatly improving the reading effect.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a three-dimensional drawing of a structure according to a preferred embodiment of the present invention from the façade view;

FIG. 2 is a three-dimensional drawing of a structure according to a preferred embodiment of the present invention from the reverse side view;

FIG. 3 is another implementation according to a preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

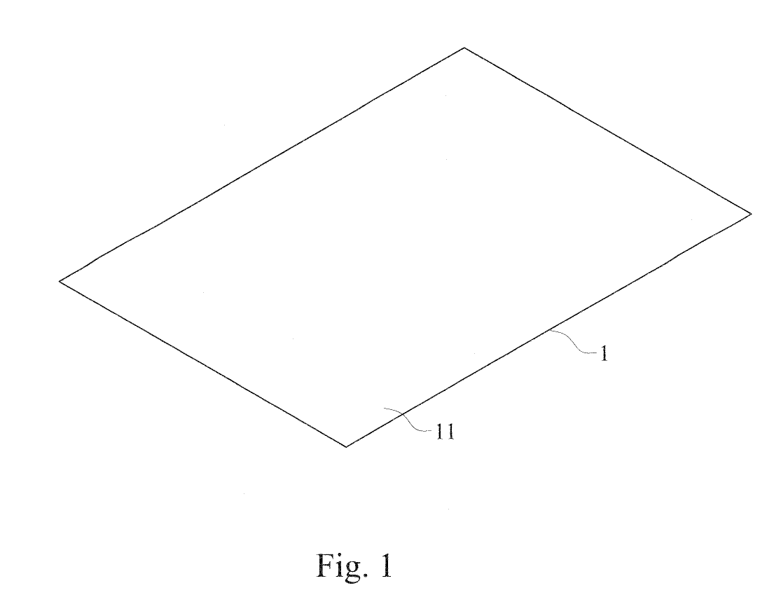

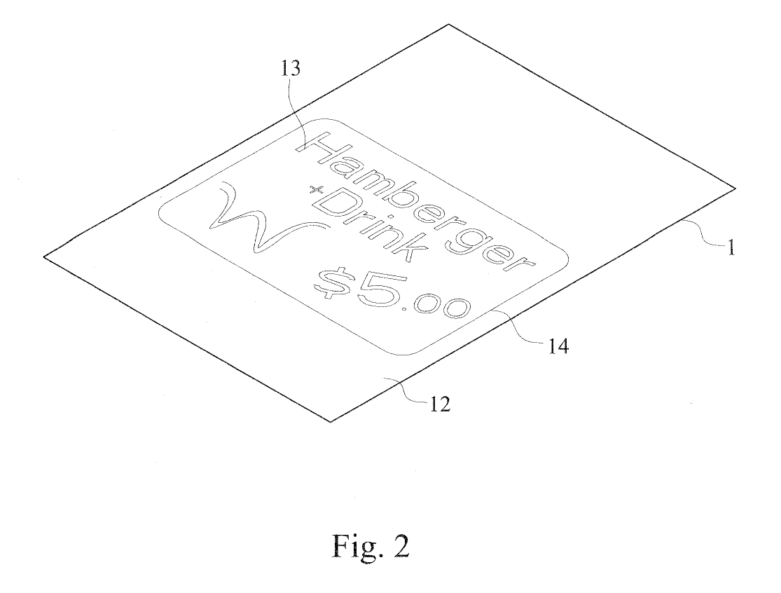

With reference to FIG. 1 and FIG. 2 for three-dimensional drawings of each visual angel according to a preferred embodiment of the invention are provided. As shown in figures, the photocopy paper 1 having pre-printed material comprises a blank surface 11, a pre-printed surface 12 and a first pattern layer 13. Moreover, the size of the photocopy paper 1 is one of specifications selected from A3, B3, A4, B4, A5 and B5 that can be normally seen. For example, the specification of A4 is adopted in the figure.

The blank surface 11 is located at a surface of the photocopy paper 1 and provided to a user to photocopy documents. The pre-printed surface 12 is located at the other surface of the photocopy paper 1 to dispose the first pattern layer 13. The first pattern layer 13 is disposed on a portion or the whole of the pre-printed surface 12 through manners of screen printing, lithography printing or computer printing. As shown in the figure, the pattern is an embodiment of full-page printing, and the first pattern layer 13 is disposed by corresponding to different advertising messages such as series advertising patterns, little stories or puzzles (games) so that the interest of readers can be enhanced to increase advertising benefits. Therefore, the first pattern layer 13 can be a script, a geometric figure and one of combination thereof. Each first pattern layer 13 can be contents of correlated advertising scripts or geometric figures or contents of respectively independent advertising scripts or geometric figures.

Further, to easily perform the typesetting for the first pattern layer 13 during the printing and improve the clean of its printing plate and convenience during reading, a first frame 14 is disposed on the pre-printed surface 12, and the first pattern layer 13 is printed therein to classify and print different first pattern layers such that readers can easily absorb the message shown on the paper to effectively enhance the advertising benefit.

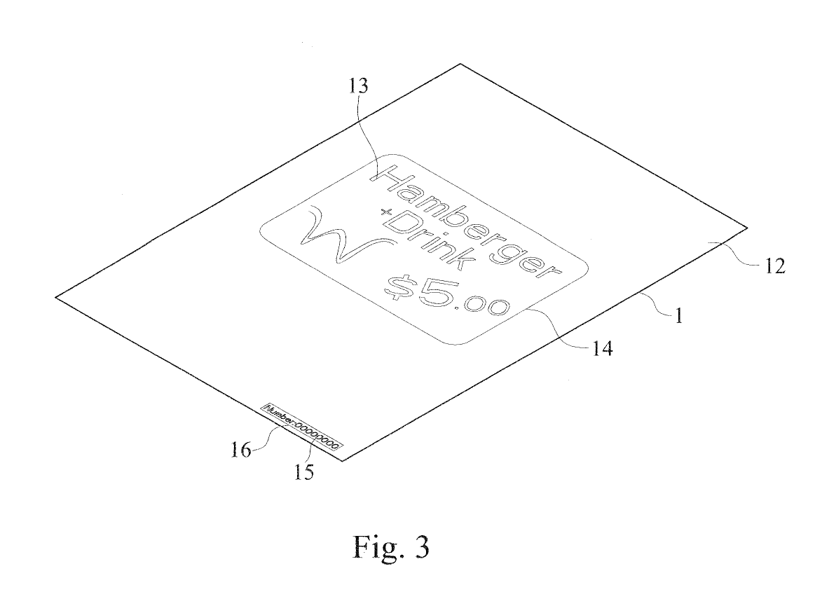

With reference to FIG. 3 for another figure according to a preferred embodiment of the invention is depicted. As shown in the figure, the pre-printed surface 12 of the photocopy paper 1 is disposed with a second pattern layer 15 at its edge or corner by means of partial disposing. The second pattern layer 15 corresponds to a number or an identification code of the advertising message to facilitate the interaction and feedback between users, readers, content providers, and advertisers for the relevant purposes. Therefore, the second pattern layer 15 is usually a script, a geometric figure or one of combination thereof. Similarly, to conveniently perform the typesetting and retain the clean of its printing plate, the edge or the corner of the pre-printing surface 12 is disposed with a second frame 16, and the inside of the second frame 16 is blank to print the second pattern layer 15.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A photocopy paper having pre-printed material for marketing advertising, the photocopy paper comprising:
a blank surface located at a surface of the photocopy paper; and
a pre-printed surface located at the other surface of the photocopy paper, the pre-printed surface having a first pattern layer, wherein the first pattern layer is disposed partial paged or fill-paged by corresponding to the pre-printed material.

2. The photocopy paper of claim 1, wherein a random corner of the pre-printed surface of the photocopy paper is disposed with a second pattern layer.

3. The photocopy paper of claim 2, wherein the second pattern layer corresponds to a number or an identification code of the advertising message.

4. The photocopy paper of claim 2, further comprising at least one second frame, wherein the second frame is disposed to the pre-printed surface, and the second pattern layer is disposed inside the second frame.

5. The photocopy paper of claim 1, wherein a size of the photocopy paper is one of specifications selected from A3, B4, A4, B3, A5 and B5.

6. The photocopy paper of claim 1, further comprising at least one first frame, wherein the first frame is disposed to a portion of or whole pre-printed surface, and the first pattern layer is disposed inside the first frame.
